(19) United States
(12) Patent Application Publication
(10) Pub. No.: US 2012/0304098 A1
(43) Pub. Date: Nov. 29, 2012

(54) METHOD AND APPARATUS FOR PROVIDING DETAILED PROGRESS INDICATORS

(75) Inventor: Mika Kuulusa, Tampere (FI)

(73) Assignee: Nokia Corporation, Espoo (FI)

(21) Appl. No.: 13/117,856

(22) Filed: May 27, 2011

(51) Int. Cl. G06F 3/048

(52) U.S. Cl. 715/772

(57) ABSTRACT

An approach is provided for providing detailed progress indicators. A progress indicator platform determines a plurality of entities associated with performing at least one task. The progress indicator platform determines progress information for performing the at least one task. Nest, the progress indicator platform processes and/or facilitates a processing of the progress information to determine task contribution information associated with respective ones of the plurality of entities. Next, the progress indicator platform causes, at least in part, a rendering of a user interface element to depict, at least in part, the progress information, the task contribution information, or a combination thereof.

### BACKGROUND

Service providers and device manufacturers (e.g., wireless, cellular, etc.) are continually challenged to deliver value and convenience to consumers by, for example, providing compelling network services. Certain network services allow multiple different entities to contribute to perform one or more tasks. For example, a group of entities can contribute to raise money for relief efforts in response to a natural disaster through social networking websites. Additionally, a group of entities, such as friends, can contribute efforts in preparing for a trip or organizing a party for another friend. However, current methods of visualizing the progress of such tasks do nothing more than visualize a total amount of the task that has been performed in comparison to the total amount necessary to perform the task. Additional information regarding, for example, the entities that have contributed to performing the task and the amounts the entities have contributed is not displayed. Thus, there is no incentive for an entity to contribute more to performing the task because there is no visual recognition of the effort the entity has contributed.

### SOME EXAMPLE EMBODIMENTS

Therefore, there is a need for an approach for providing detailed progress indicators.

According to one embodiment, a method comprises determining a plurality of entities associated with performing at least one task. The method also comprises determining progress information for performing the at least one task. The method further comprises processing and/or facilitating a processing of the progress information to determine task contribution information associated with respective ones of the plurality of entities. The method also comprises causing, at least in part, a rendering of a user interface element to depict, at least in part, the progress information, the task contribution information, or a combination thereof

According to another embodiment, an apparatus comprises at least one processor, and at least one memory including computer program code for one or more programs, the at least one memory and the computer program code configured to, with the at least one processor, cause, at least in part, the apparatus to determine a plurality of entities associated with performing at least one task. The apparatus is also caused to determine progress information for performing the at least one task. The apparatus is further caused to process and/or facilitate a processing of the progress information to determine task contribution information associated with respective ones of the plurality of entities. The apparatus is further caused, at least in part, to render a user interface element to depict, at least in part, the progress information, the task contribution information, or a combination thereof.

According to another embodiment, a computer-readable storage medium carries one or more sequences of one or more instructions which, when executed by one or more processors, cause, at least in part, an apparatus to determine a plurality of entities associated with performing at least one task. The apparatus is also caused to determine progress information for performing the at least one task. The apparatus is further caused to process and/or facilitate a processing of the progress information to determine task contribution information associated with respective ones of the plurality of entities. The apparatus is also caused, at least in part, to render a user interface element to depict, at least in part, the progress information, the task contribution information, or a combination thereof.

According to another embodiment, an apparatus comprises means for determining a plurality of entities associated with performing at least one task. The apparatus also comprises means for determining progress information for performing the at least one task. The apparatus further comprises means for processing and/or facilitating a processing of the progress information to determine task contribution information associated with respective ones of the plurality of entities. The apparatus also comprises means for causing, at least in part, a rendering of a user interface element to depict, at least in part, the progress information, the task contribution information, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing detailed progress indicators, according to one embodiment;

FIG. 2 is a diagram of the components of a progress indicator platform, according to one embodiment;

FIG. 3 is a flowchart of a process for providing detailed progress indicators, according to one embodiment;

FIGS. 4A-4E are diagrams of progress indicators utilized in the process of FIG. 3, according to various embodiments;

FIGS. 5A and 5B are diagrams of progress indicators with additional information utilized in the process of FIG. 3, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing detailed progress indicators are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

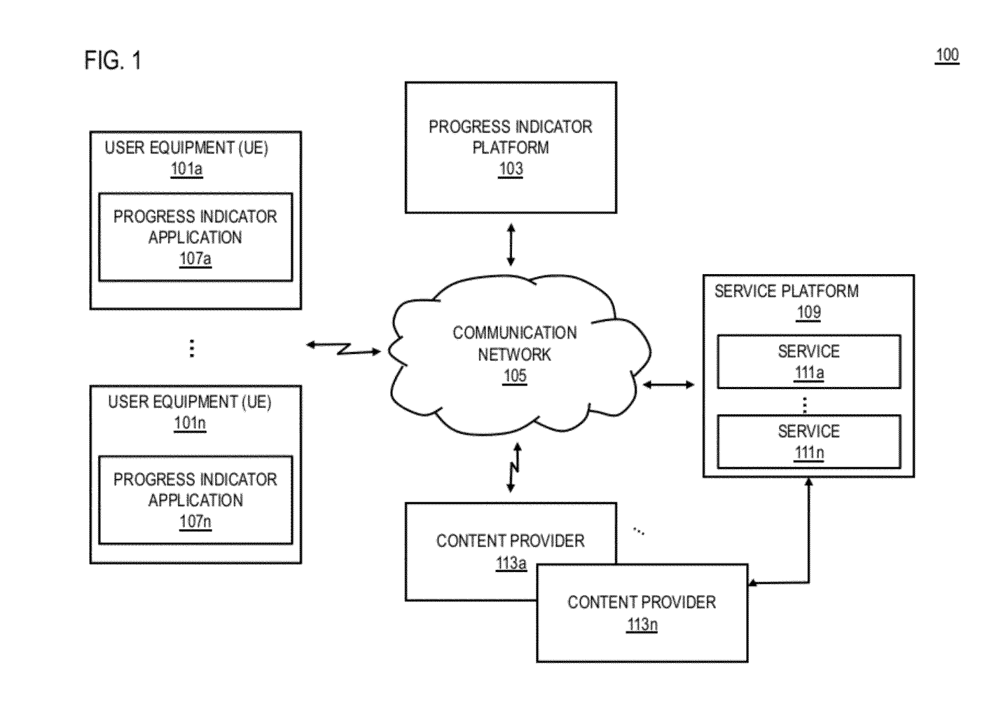

FIG. 1 is a diagram of a system capable of providing detailed progress indicators, according to one embodiment. As discussed above, a conventional progress bar merely illustrates the total progress of performing a task. By way of example, the entire length of a conventional progress bar illustrates the amount of work needed to completely perform the task and the length of a highlighted bar within the conventional progress bar illustrates the amount of work that has already been performed. However, the extent of the work that has been performed is the only information that is communicated by the conventional progress bar. Thus, specific entities that have contributed a great deal of effort in performing the task do not get recognition for their work. Likewise, specific entities that have contributed almost no work have little to no other motivating factors for contributing more work.

To address this problem, among others, a system 100 of FIG. 1 introduces the capability to generate and present detailed progress indicators as part of a user interface elements that, for example, illustrate the amounts that each contributing entity has contributed to performing a task. The detailed progress indicator can, by way of example, divide the amount of work that has already been performed into the respective amounts of work that each entity has contributed in performing the task. Thus, entities that have contributed a great amount towards performing a task are given visual recognition for their work. Likewise, entities that have contributed no work, or almost no work, are given a visual recognition, or lack thereof, for their lack of work as a motivational factor towards contributing more towards the task.

In one embodiment, if the task can be broken down into subtasks, the system 100 of FIG. 1 introduces the capability to generate and present a detailed progress indicator that breaks down the work performed by the entities into respective amounts of work directed towards each subtask. Thus, a visual indication is presented for entities that contribute a great amount of work over the entire range of subtasks and for entities that contribute a great amount of work to only one subtask and not the entire subtasks required to perform the main task.

In one embodiment, the system 100 of FIG. 1 introduces the capability to visualize an amount of work performed compared to a task contribution goal associated with an entity that can represent, for example, an amount of work an entity is responsible for performing. In some situations, entities that contribute to performing the task are assigned and/or volunteer task contribution goals that the entities are responsible for towards performing the task. By way of example, four friends are contributing to raising money (e.g., $1000). Friend A is responsible for raising $500, Friends B and C are each responsible for raising $200, and Friend D is responsible for raising $100. By way of the detailed progress bar, each amount the four friends have raised can be illustrated in comparison to the total amount of money the friends want to raise (e.g., $1000) and in comparison to each amount each friend is individually responsible for (e.g., $500, $200, or $100). Thus, for example, if Friend A has raised $300 and Friends B, C, and D have raised $200, $195 and $100, respectively, despite Friend A having raised more money, the detailed progress indicator can illustrate that Friends B, C, and D have almost, or already, raised their task contribution goals.

In one embodiment, the system 100 of FIG. 1 introduces the capability to visually indicate a top contributor, a bottom contributor, or a combination thereof. By way of example, the system 100 can generate a detailed progress indicator that indicates the top contributing entity as motivational factor for other entities to attempt to contribute more. The system 100 can also generate a detailed progress bar that indicates the bottom contributing entity as a motivational factor for that entity to contribute more to performing the task.

In one embodiment, the system 100 introduces the capability to visually indicate the amount a task has been performed in the format of a progress bar, a pie chart, a graph, a visualization of an object (e.g., a building, a container, a person, etc.), a race (e.g., start to finish), etc.

In one embodiment, the entities that contribute to performing the task can be individuals, social groups, religious groups, work groups, gaming clans, regions, cities, countries, continents, anonymous entities or a combination thereof.

As shown in FIG. 1, the system 100 comprises one or more user equipment (UE) 101a-101n (collectively referred to as UE 101) having connectivity to a progress indicator platform 103 via a communication network 105. Each UE 101 can run one or more applications, including progress indicator applications 107a-107n that interface with the progress indicator platform 103 for rendering detailed progress indicators on the UE 101. The system 100 also comprises a service platform 109 running one or more services 111a-111n (collectively referred to as services 111) (e.g., location based services, mapping information, social networking services, etc.) accessible to one or more users through respective UE 101. The system 100 also comprises one or more content providers 113a-113n (collectively referred to as content providers 113) that provide content to the services 111 of the service platform 109, the progress indicator platform 103 or the UE 101.

By way of example, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the progress indicator platform 103, the service platform 109 and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

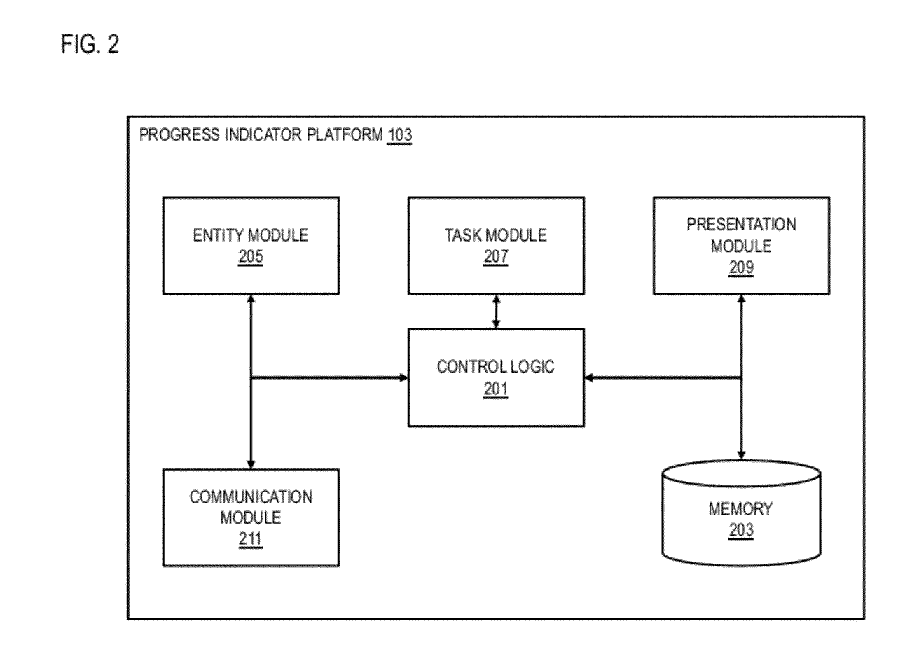

FIG. 2 is a diagram of the components of the progress indicator platform 103, according to one embodiment. By way of example, the progress indicator platform 103 includes one or more components for providing detailed progress indicators. It is contemplated that the functions of these components may be combined in one or more components or performed by other components of equivalent functionality. For example, in one embodiment, the functions of the progress indicator platform 103 can be embodied in one or more services 111 of the service platform 109, in one or more applications running on the UE 101 (e.g., such as a peer-to-peer (P2P) configuration), or one or more hardware modules of the UE 101.

In this embodiment, the progress indicator platform 103 includes control logic 201, a memory 203, an entity module 205, a task module 207, a presentation module 209 and a communication module 211. The control logic 201 executes one or more algorithms for performing and/or coordinating the functions of the progress indicator platform 103. The memory 203 stores information used by the progress indicator platform 103, such as one or more tasks and their respective subtasks, entities associated with performing the one or more tasks and subtasks, task contribution goals associated the entities in performing the one or more tasks, etc. The communication module 211 communicates with the UE 101, the services 111 of the service platform 109 and the content providers 113 to exchange information for implementing the provision of detailed progress indicators.

The entity module 205 collects, registers and/or tracks the entities involved in performing one or more tasks. By way of example, the entity module 205 by way of the communication module 211 communicates with a service 111a running on the service platform 109 to create a detailed progress indicator. The entity module 205 communicates with the service 111a and determines the number of entities that are registered with the service 111a and that are associated with performing a task. For example, the progress indicator platform 103 communicates with a social networking website to determine the registered participants of a charitable organization's money drive. The entity module 205 determines the number of entities and their respective information (e.g., login names, address, phone number, e-mail address, social networking information, etc.). The entity module 205 stores the collected information in the memory 203.

In one embodiment, the entity module 205 can also communicate with progress indicator applications 107 running on the UE 101 to determine the entities that are involved in performing a task. For example, either one or both of the progress indicator platform 103 and the progress indicator applications 107 can communicate with the other to communicate information regarding the entities associated with performing a task, including communicating the same information as discussed above.

In one embodiment, the entity module 205 also determines whether one or more entities have a task contribution goal, such as an assigned/proposed/donated amount that the entities are responsible for in performing one or more main tasks. For example, one entity may be responsible for 50% of the work required for performing a main task. Thus, the work that the entity has performed can be visualized with respect to the entire amount of work that is required to perform the task and/or with respect to the amount of work that the entity is responsible for in performing the task (e.g., with respect to the task contribution goal).

By way of example, entities can comprise individuals, social groups, religious groups, work groups, gaming clans, regions, cities, countries, continents, anonymous entities or a combination thereof. When the entities comprise large groups, such as regions, cities, countries and continents, the specific entities that make up the larger entities can either register as part of the larger entities or the entity module 205 can automatically assemble the larger entities from information regarding the smaller entities, such as address information, ISP location, etc. By way of example, in one situation individuals work towards performing a task but the work for the individuals is visualized in the detailed progress indicator based on the individuals' countries of origin. When one or more entities perform work without being registered, the entities are indicated as anonymous entities or part of a larger group of entities that has the same effect of rendering the specific entity anonymous.

The task module 207 collects, registers and/or tracks one or more main tasks that the one or more entities are involved in performing. The task module 207 also collects, registers and/or tracks one or more subtasks for any of the one or more main tasks that the one or more entities are involved in performing. By way of example, the task module 207 by way of the communication module 211 communicates with a service 111a running on the service platform 109 to determine one or more tasks that are in any stage of being performed (e.g., no work done, some work done, all work done). The progress indicator platform 103 also determines whether the one or more tasks have subtasks. The task module 207 registers this information in the memory 203. In one embodiment, the task module 207 by way of the communication module 211 communities with progress indicator applications 107 running on UEs 101 to determine one or more tasks and their respective subtasks.

The presentation module 209 processes information regarding the entities and the one or more main tasks and subtasks for creating a user interface element that depicts, at least in part, a detailed progress indicator of the amount of work performed for the one or more main tasks and subtasks. By way of example, if four entities are working towards performing a task, the presentation module 209 formats the amount of work each entity has performed in proportion to the total amount of work performed and displays this information as part of the detailed progress indicator. The presentation module 209 can also format the detailed progress indicator to include the amount of work performed by an entity with respect to the total work necessary to completely perform the task and the amount of work associated with the task contribution goal associated with the entity. The presentation module 209 can also include other information as part of, or associated with, the detailed progress indicator within the user interface element, such as indications of the entities that have performed the most and least amount of work, information that the entities post to the detailed progress indicator (e.g., messages to other entities), social networking information, advertising information, messaging information, coupon information, or a combination thereof. By way of example, an advertisement can be related to the task that the entities are working towards performing. Examples of the formatting type of the detailed progress indicators of the user interface element comprise a progress bar, a pie chart, a graph, a visualization of an object (e.g., a building, a container, a person, etc.), a race (e.g., start to finish), etc.

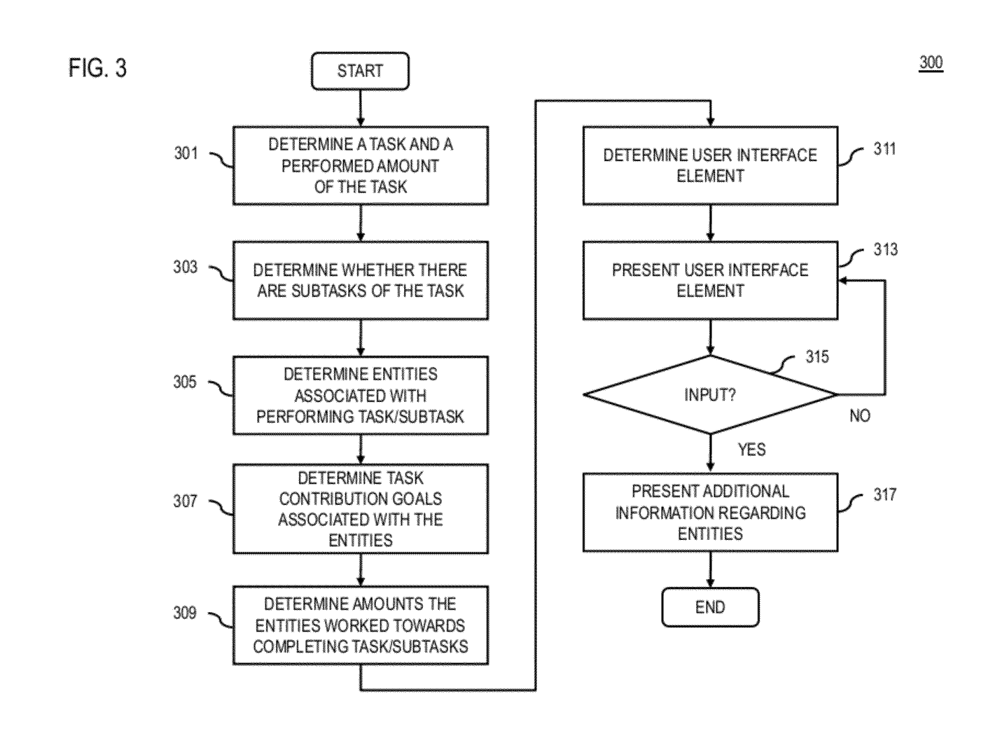

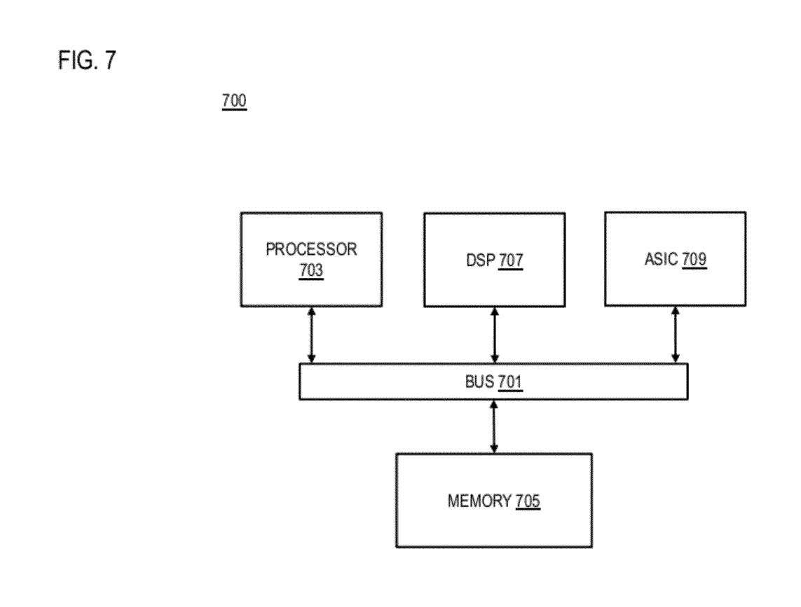

FIG. 3 is a flowchart of a process for providing detailed progress indicators, according to one embodiment. In one embodiment, the progress indicator platform 103 performs the process 300 and is implemented in, for instance, a chip set including a processor and a memory as shown in FIG. 7. In step 301, the progress indicator platform 103 determines a main task for which a user interface element including a detailed progress indicator should be generated and how much of the main task has been performed. In one example, friends are collecting money through a social networking website running as a service 111a on the service platform 109. The progress indicator platform 103 determines that a detailed progress indicator is required and determines how much money has been raised by communicating with the service 111a (e.g., $775 has been raised out of a total of $1000). The progress indicator platform 103 determines that a detailed progress indicator is requested based on inputs from one or more services 111 of the service platform 109, from one or more progress indicator applications 107 running on the UE 101, one or more content providers 113, or a combination thereof.

In step 303, the progress indicator platform 103 determines whether there are subtasks associated with the main task. Depending on the specific main task, there may or may not be subtasks. By way of example, if a total sum of money is being collected, the sum of money may be distributed to different organizations, such that the money being collected for each different organization represents a subtask of the main task. Alternatively, if the entire sum of money being collected is going to one organization there would be no subtasks associated with the main task.

In step 305, the progress indicator platform 103 determines the entities associated with performing the main task. In one embodiment, the entities are registered with the service 111a that is hosting the task and are associated with the task. The progress indicator platform 103 interfaces with the service 111a to collect the information regarding the entities associated with the task. In one embodiment, the entities that are associated with performing a main task register directly with the progress indicator platform 103. In one embodiment, the entities that are associated with performing a main task or subtasks associated with a main task do not have to be registered. Instead, the entities are considered anonymous entities and task contribution information associated with the anonymous entities appears as having been performed by anonymous entities in the detailed progress indicator.

In step 307, the progress indicator platform 103 determines whether there are any task contribution goals associated with the entities for performing the main task and, if subtasks exist, the subtasks. By way of example, four friends are raising money to donate to their fifth friend for a medical procedure that the fifth friend needs. Because Friend A has multiple contacts that have donated money in the past, Friend A is given a larger responsibility for raising money (e.g., 50%). Because Friend D just had a baby, Friend D is given a smaller responsibility for raising money (e.g., 10%). Friends B and C decide to split the remaining amount that needs to be raised equally (e.g., each has a task contribution goal for 20%). If the main task had one or more subtasks (e.g., raising money for Friend E's family while Friend E is recovering), the task contribution goals for the one or more subtasks can similarly be divided. The progress indicator platform 103 can then determine the task contribution goals for each entity with respect to the main task and subtasks and include this information in the detailed progress indicator. However, for some main tasks or subtasks, the entities will not have task contribution goals associated with performing the main tasks or the subtasks. Thus, in these situations, the process 300 determines that the amounts are zero at step 307, or in the alternative, proceeds directly to step 309.

In step 309, the progress indicator platform 103 determines the amounts the entities have worked towards performing the task, and one or more subtasks, if any. The progress indicator platform 103 determines the amounts the entities have worked by, for example, interfacing with the services 111 on the service platform 109 that are hosting the main tasks. By way of example, in relation to the example discussed above, the progress indicator platform 103 determines the amount of money the four Friends A-D have raised for Friend E by interfacing with the service 111a used in collecting the money.

In step 311, the progress indicator platform 103 determines a user interface element including the detailed progress indicator that illustrates the amounts that the entities have worked towards performing the task, and one or more subtasks, if any. In one embodiment, the detailed progress indicator also includes the amounts that the entities have worked towards performing the task and any subtasks in relation to any task contribution goals associated with the entities. The detailed progress indicator can be in any format, such as a progress bar, a pie chart, a graph, a visualization of an object (e.g., a building, a container, a person, etc.), a race (e.g., start to finish), etc. The format of the amounts the entities have worked also can be graphically represented in many forms. For example, in the case of a progress bar, the amounts the entities have worked can be presented as solid bars in proportion to the total amount of work required to perform the main task, which can be represented by the entire length of the progress bar. The amounts the entities have worked can also be presented in chronological order, such as when each entity worked a discrete amount of work towards performing a main task, or a subtask of a main task. There can also be multiple formats within the same detailed progress indicator. For example, one subtask can be represented by a progress bar format with the total amounts each entity worked represented by solid bars and one subtask can be represented by a progress bar format with the discrete amounts each entity worked presented in chronological order of when the work was performed.

In step 313, the progress indicator platform 103 presents the user interface element including the detailed progress indicator of the amounts the one or more entities worked towards performing the main task, and one or more subtasks, if any. By way of example, if one or more entities are using a service 111a to perform a main task, the detailed progress indicator included in the user interface element is presented for the service 111a to one or more UEs 101 associated with the entities that worked towards performing the main task, and one or more subtasks.

At step 315, the progress indicator platform 103 determines whether it receives an input. By way of example, an input could comprise a mouse gesture, such as moving a mouse cursor over the detailed progress indicator, or other selection of the detailed progress indicator and a representation of an amount that an entity worked in performed the task. If the progress indicator platform 103 receives an input, the process 300 proceeds to step 317. If the progress indicator platform 103 does not receive an input, the process 300 reverts back to step 313.

In step 317, the progress indicator platform 103 presents additional information regarding the amounts the entities have worked or details regarding the entities themselves as part of the user interface element. For example, the progress indicator platform 103 indicates which of the entities has the largest amount towards performing the main task. The progress indicator platform 103 can also indicate which of the entities has the smallest amount towards performing the main task. The progress indicator platform 103 can also present information that the entities publish to the detailed progress indicator, such as their current status at a point in time if the amounts the entities have worked are presented in a chronological order. The progress indicator platform 103 also can present information regarding social networking information, advertising information, messaging information, coupon information, or combination.

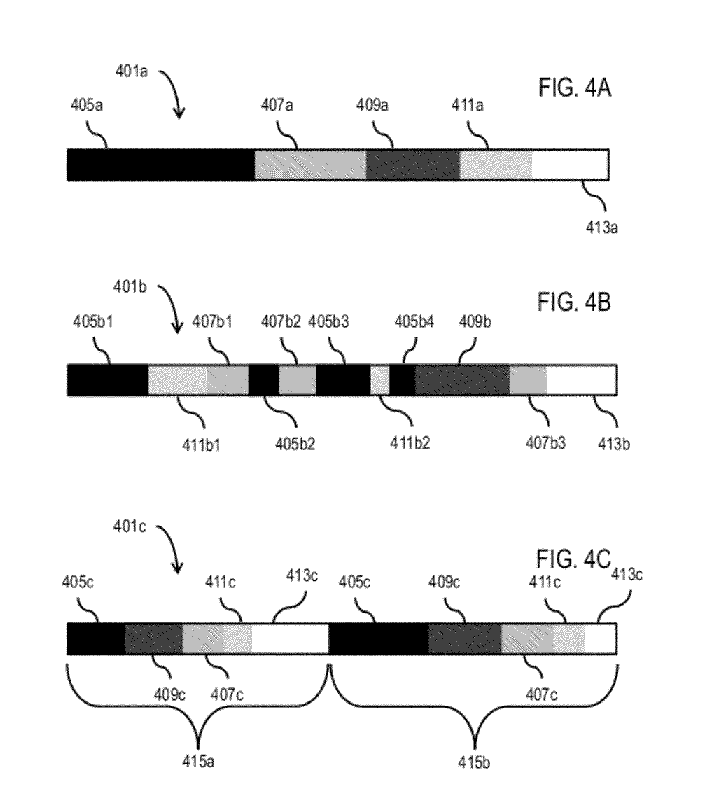

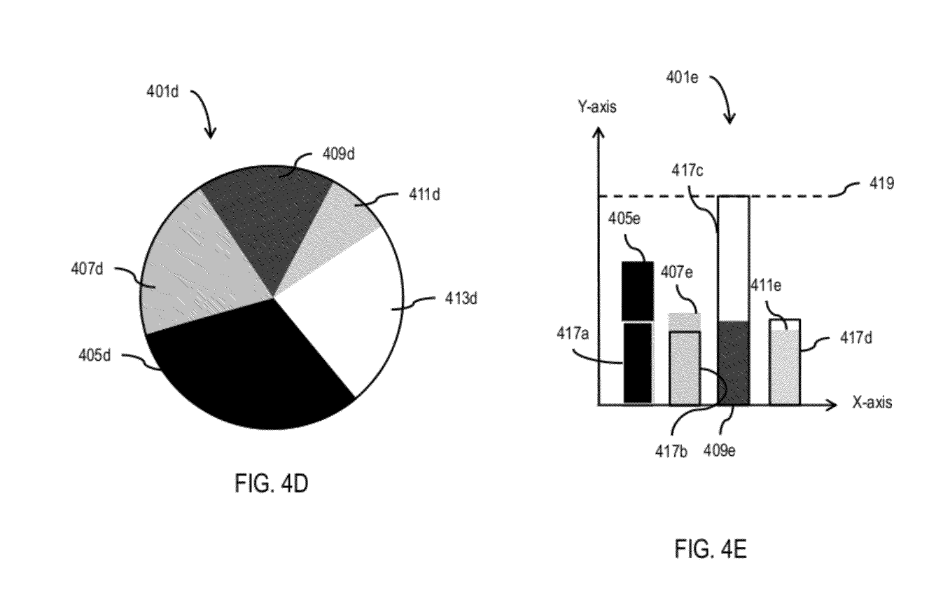

FIGS. 4A-4E are diagrams of progress indicators utilized in the process of FIG. 3, according to various embodiments. FIG. 4A illustrates a detailed progress indicator 401 a in the format of a progress bar. The detailed progress indicator 401a illustrates the total amounts 405a, 407a, 409a, and 411a that each entity (e.g., Friend A-D) has performed towards performing the main task. Each of the total amounts (405a-411a) represents the total amount each entity worked illustrated as solid bars in proportion to the length of the detailed progress indicator 401a (total amount of work) and in the order of the size of the amounts. The work performed by each entity is distinguished from the work performed by other entities according to identification basis (e.g., color, shade, texture, pattern, etc.). The total amount 413a that is not filled in by some type of identification basis represents the amount of work still needed to be performed.

As can be seen, the entity represented by the total amount 405a has performed the largest amount of work among the four entities, while the entities represented by the total amounts 407a, 409a and 411a have all performed lesser amounts of work. The entity associated with the total amount 411a has performed the least amount of work. As illustrated, the total amount 405a is distinguished as the largest amount of work performed by being the farthest left of the total amounts 405a, 407a, 409a and 411a in the detailed progress indicator 401a. The total amount 411a is distinguished as the least amount of work performed by being the farthest right of the total amounts 405a, 407a, 409a and 411a in the detailed progress indicator 401a. In one embodiment, the largest amount of work performed may be distinguished by being the farthest right amount of work performed and the least amount of work performed may be distinguished by being the farthest left amount of work.

FIG. 4B illustrates a detailed progress indicator 401b in the format of a progress bar with each discrete amount of work performed by the four entities presented in chronological order of when the discrete amount of work was performed, with the left end of the detailed progress indicator 401b representing the time when the first entity performed the first discrete amount of work and the right end of the detailed progress indicator 401b representing the point in time when the last discrete amount of work is performed to complete the task. The amount 413b represents the amount of work still needed to be performed.

When the first entity performs work, that work is displayed on the detailed progress bar indicator according to an identification basis (e.g., color, shade, texture, fill pattern etc.) starting from the left side of the detailed progress indicator 401b. When the next entity performs work, that work is displayed on the detailed progress bar indicator according to another identification basis. As each new entity performs work, the identification basis continues to distinguish each entity's work from the other entities and the work is presented in the chronological order of when the work was performed.

As illustrated in FIG. 4B, the entities represented by the amounts 405b (e.g., 405b1-405b4), 407b (e.g., 407b1-407b3), and 411b (e.g., 411b1-411b2) each started and stopped performing work over a period of time since the beginning, with the entity represented by the first discrete amount of work 405a1 being the first entity to perform work. The entity represented by the next discrete amount 411b1 was the second entity to perform work. The entity represented by the next discrete amount 407b1 was the third entity to perform work. The entity represented by the amount 409b worked only one time since the beginning of the work. The entity represented by the last discrete amount of work 407b3 was the last entity to perform work. In one embodiment, the right end of the detailed progress indicator 401b represents the point in time when the first amount of work is performed and the left end of the detailed progress indicator 401b represents the point in time in the future when the last amount of work is performed to complete the task.

FIG. 4C illustrates a detailed progress indicator 401c in the format of a progress bar where the main task comprises two subtasks 415a and 415b. Each of the amounts 405c, 407c, 409c and 411c performed by the four entities are divided into the two subtasks 415a and 415b. The amounts 413c represent the amount of worked still needed to be performed for each of the subtasks 415a and 415b. In one embodiment, the amounts 405c, 407c, 409c, and 411c can be displayed as the total amounts worked as discussed above regarding FIG. 4A, as the discrete amounts worked in chronological order as discussed above regarding FIG. 4B, or a combination thereof for each subtask (e.g., one subtask is displayed one way and the other subtask is displayed a different way).

FIG. 4D illustrates a detailed progress indicator 401d in the format of a pie chart. The amounts 405d, 407d, 409d and 411d performed are represented by different sized pie pieces proportional to the amount of work required to perform the main task. The amount 413d represents the amount of work left to complete the main task. In one embodiment, the amounts 405d, 407d, 409d and 411d are ordered according to the amounts that each entity worked. For example, any radius of the pie can represent a “beginning” where the largest pie piece is displayed, and the smaller pie pieces are arranged either clockwise or counter-clockwise in proportion to the amounts of work they represent. In one embodiment, in the case of a chronological ordering, any radius of the pie can represent a “beginning” where the first discrete amount of work performed is displayed, and the other discrete amounts of work that are performed are arranged in a clockwise or counter-clockwise position with respect to the beginning

FIG. 4E illustrates a detailed progress indicator 401e in the format of a graph. The amounts 405e, 407e, 409e and 411e performed are plotted as bars on the graph. The detailed progress indicator 401e includes amounts 417a, 417b, 417c and 417d that indicate the task contribution goals for each of the four entities. As illustrated in the detailed progress indicator 401e, the entities associated with amounts 405e and 407e have exceeded their respective task contribution goals and the entities associated with amounts 409e and 411e have yet to exceed their respective task contribution goals. Indicator 419 illustrates the completion of performing the task, which is achieved, for example, when one of the plotted bars reaches the indicator 419. As the amounts the respective entities have performed changes, the distance of the indicator 419 from the x-axis changes to adjust for the amount of work that is left to be performed. As illustrated in FIG. 4E, the amounts 405e, 407e, 409e, and 411e are in the order of the size of the amount with the largest amount being the farthest left and the smallest amount being the farthest right. In one embodiment, the largest amount can be the farthest right and the smallest amount can be the farthest left. In one embodiment, each one of the amounts 405e, 407e, 409e, and 411e are divided into discrete amounts according to when each discrete amount was worked for each amount 405e, 407e, 409e, and 411e, which is displayed when each one of the discrete amounts 405e, 407e, 409e, and 411e are selected (e.g., by hovering a cursor over the amounts, by clicking on the amounts using a cursor, etc.).

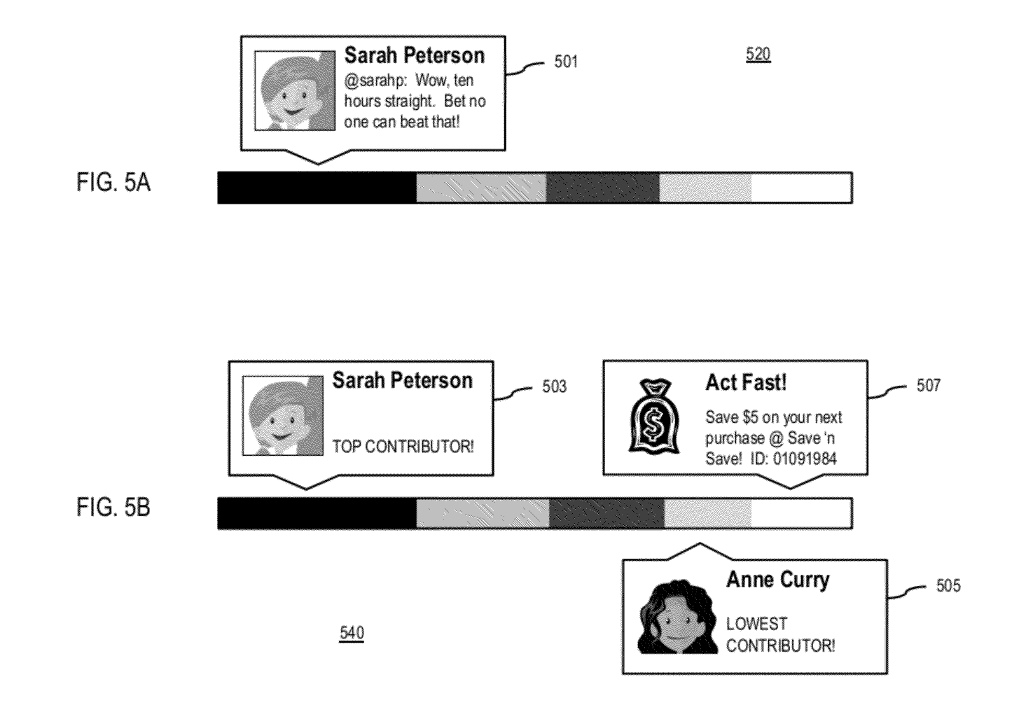

FIGS. 5A and 5B are diagrams of user interface elements 520 and 540 including detailed progress indicators utilized in the process of FIG. 3, according to various embodiments. As illustrated in FIG. 5A, the user interface element 520 can include one or more information blocks, including information regarding social networking information, advertising information, messaging information, coupon information, or a combination thereof. An entity can add one or more messages 501 associated with the amounts worked toward performing the main task. By way of example, the entity can be an individual that leaves a message 501 regarding the amount of work, the amount of time they worked, etc. towards performing the main task. As illustrated in FIG. 5B, the user interface element 540 also can include a message regarding the highest contributor 503 and/or a message regarding the lowest contributor 505 towards performing the main task. The user interface element 540 can also include additional messages, such as an advertising message 507.

The processes described herein for providing detailed progress indicators may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

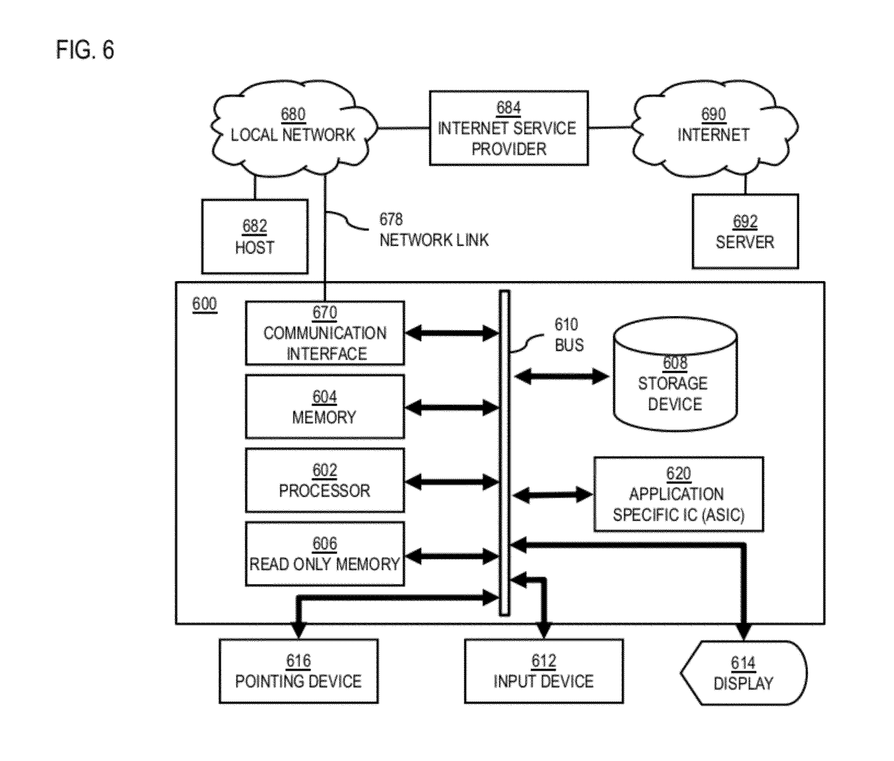

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of computer system 600. Computer system 600 is programmed (e.g., via computer program code or instructions) to provide detailed progress indicators as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing detailed progress indicators.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing detailed progress indicators. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing detailed progress indicators. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing detailed progress indicators, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing detailed progress indicators to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer system 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide detailed progress indicators as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing detailed progress indicators.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to providing detailed progress indicators. The memory 705 also stores the data associated with or generated by the execution of the inventive steps.

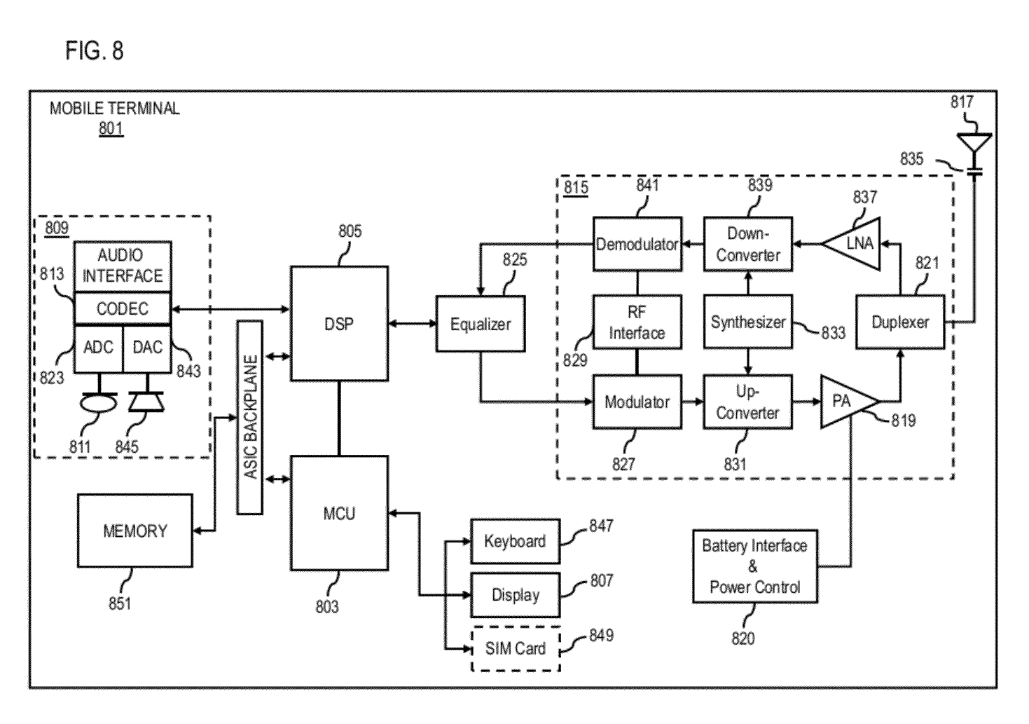

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing detailed progress indicators. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing detailed progress indicators. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to providing detailed progress indicators. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a plurality of entities associated with performing at least one task;
progress information for performing the at least one task;
a processing of the progress information to determine task contribution information associated with respective ones of the plurality of entities; and
a rendering of a user interface element to depict, at least in part, the progress information, the task contribution information, or a combination thereof

2. A method of claim 1, wherein the (1) data and/or (2) information and/or (3) at least one signal are further based, at least in part, on the following:
a processing of the task contribution information to determine an order of the plurality of entities,
wherein the rendering of the user interface element is based, at least in part, on the order.

3. A method of claim 1, wherein the (1) data and/or (2) information and/or (3) at least one signal are further based, at least in part, on the following:
a processing of the progress information, the task contribution information, or a combination thereof to determine a time domain associated with the at least one task,
wherein the rendering of the user interface element is based, at least in part, on the time domain.

4. A method of claim 3, wherein the (1) data and/or (2) information and/or (3) at least one signal are further based, at least in part, on the following:
a chronological order of when at least one or more portions of the at least one task was performed by the plurality of entities,
wherein the time domain is based, at least in part, on the chronological order.

5. A method of claim 1, wherein the (1) data and/or (2) information and/or (3) at least one signal are further based, at least in part, on the following:
an input for selecting at least a portion of the user interface element that corresponds to at least one of the plurality of entities; and
a presentation of information related to the at least one of the plurality of entities, the at least one task, or a combination thereof.

6. A method of claim 5, wherein the information includes, at least in part, social networking information, advertising information, messaging information, coupon information, or a combination thereof.

7. A method of claim 6, wherein the (1) data and/or (2) information and/or (3) at least one signal are further based, at least in part, on the following:
one or more task contribution goals associated with the at least one task, the plurality of entities, or a combination thereof; and
a rendering of the one or more task contribution goals in the user interface element.

8. A method of claim 1, wherein the (1) data and/or (2) information and/or (3) at least one signal are further based, at least in part, on the following:
one or more subtasks, one or more other tasks, or a combination thereof associated with the at least one task,
wherein the rendering of the user interface element, the progress information, the task contribution information, or a combination thereof are further based, at least in part, on the one or more subtasks, the one or more other tasks or a combination thereof.

9. A method of claim 1, wherein the (1) data and/or (2) information and/or (3) at least one signal are further based, at least in part, on the following:
a rendering of one or more highlights in the user interface element to indicate at least one of the plurality of entities based, at least in part, on the progress information, the task contribution information, or a combination thereof.

10. A method of claim 1, wherein the user interface element includes, at least in part, a progress bar, a pie chart, a graph, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a plurality of entities associated with performing at least one task;
determine progress information for performing the at least one task;
process and/or facilitate a processing of the progress information to determine task contribution information associated with respective ones of the plurality of entities; and
cause, at least in part, a rendering of a user interface element to depict, at least in part, the progress information, the task contribution information, or a combination thereof.

12. An apparatus of claim 11, wherein the apparatus is further caused to:
process and/or facilitate a processing of the task contribution information to determine an order of the plurality of entities,
wherein the rendering of the user interface element is based, at least in part, on the order.

13. An apparatus of claim 11, wherein the apparatus is further caused to:
process and/or facilitate a processing of the progress information, the task contribution information, or a combination thereof to determine a time domain associated with the at least one task,
wherein the rendering of the user interface element is based, at least in part, on the time domain.

14. An apparatus of claim 13, wherein the apparatus is further caused to:
determine a chronological order of when at least one or more portions of the at least one task was performed by the plurality of entities,
wherein the time domain is based, at least in part, on the chronological order.

15. An apparatus of claim 11, wherein the apparatus is further caused to:
receive an input for selecting at least a portion of the user interface element that corresponds to at least one of the plurality of entities; and
cause, at least in part, a presentation of information related to the at least one of the plurality of entities, the at least one task, or a combination thereof.

16. An apparatus of claim 15, wherein the information includes, at least in part, social networking information, advertising information, messaging information, coupon information, or a combination thereof.

17. An apparatus of claim 16, wherein the apparatus is further caused to:
determine one or more task contribution goals associated with the at least one task, the plurality of entities, or a combination thereof; and
cause, at least in part, a rendering of the one or more task contribution goals in the user interface element.

18. An apparatus of claim 11, wherein the apparatus is further caused to:
determine one or more subtasks, one or more other tasks, or a combination thereof associated with the at least one task,
wherein the rendering of the user interface element, the progress information, the task contribution information, or a combination thereof are further based, at least in part, on the one or more subtasks, the one or more other tasks or a combination thereof.

19. An apparatus of claim 11, wherein the apparatus is further caused to:
cause, at least in part, a rendering of one or more highlights in the user interface element to indicate at least one of the plurality of entities based, at least in part, on the progress information, the task contribution information, or a combination thereof.

20. An apparatus of claim 11, wherein the user interface element includes, at least in part, a progress bar, a pie chart, a graph, or a combination thereof.

21-48. (canceled)
